(19) United States
(12) Patent Application Publication
(10) Pub. No.: US 2004/0236754 A1
(43) Pub. Date: Nov. 25, 2004

(54) Method and system for linking data across multiple files

(75) Inventors: Brad Workman, Exton, PA (US); David Fouche, Exton, PA (US); Jim Barr, Huntsville, PA (US); Shaun Sewall, Exton, PA (US); Tom Chmielenski, Exton, PA (US); George Dulchinos, Exton, PA (US)

Correspondence Address: VENABLE, BAETJER, HOWARD AND CIVILETTI, LLP, P.O. BOX 34385, WASHINGTON, DC, 20043-9998, US

(73) Assignee: Bentley Systems, Inc., Exton, PA (US)

(21) Appl. No.: 10/442,121

(22) Filed: May 21, 2003

(51) Int. Cl. G06F 17/30

(52) U.S. Cl. 707/10

(57) ABSTRACT

A method of maintaining a bidirectional link between data in a file checked-out from a content management system to a user computer and data in at least one file maintained at the content management system is provided. In the method, a first file is scanned at least when it is one of checked in and checked out of the document management system to locate a link in the file. Information is gathered from the first file regarding a source and target of the link. It is determined if an element in the file is the source or the target. The information is the stored in a database. The information in the database is automatically updated when a second file is corresponding to the other end of the link is checked in to the document management system to reflect changes made to the end of the link in the second file. The changes are applied to the information in the first file.

### FIELD OF THE INVENTION

The present invention relates generally to systems and methods for managing data and more particularly for establishing and maintaining links between data in different files.

### BACKGROUND OF THE INVENTION

Computer-aided design (CAD) drawings prepared by architects, engineers, designers, planners, and the like require large amounts of data to be stored in files. CAD software includes an API to access the large quantities of data. Applications such as, e.g., MicroStation® products, which are developed by Bentley Systems, Inc., Exton, Pa. U.S.A., and AutoCAD® products, which are developed by Autodesk, Inc., San Rafael, Calif., U.S.A. are typical of such CAD software, which may be used in the Architectural Engineering, and Construction (AEC) marketplace.

A typical CAD project employed in the engineering context is stored in numerous files. Some projects include hundreds of files. Each file typically contains one or more engineering models, each of which represents an engineering domain (e.g., structural, electrical, mechanical, plumbing). Moreover, each engineering model requires numerous items represented by a series of elements to support the complex and precise nature of each design. In this context, the term “element” is used to mean a record containing a variable number of bytes of data arranged in a format that can be interpreted by a program. The term “element” differs from the common notion of an “object” in that each element can have a variable number of bytes, whereas the size of an object is typically defined by its class. Each item in a model is represented by at least one element or an aggregation of elements. For example, a structural drawing can include the column and beam layout for a floor plan, which are internally represented by lines, squares and rectangles and additional properties.

Firms that provide AEC professional design services have a need to manage and coordinate drawings and specifications throughout a project. The individuals that create and manage these documents are design professionals of all disciplines, including architects, structural engineers, and process and discreet manufacturing plant designers. Drawings are the primary means of communicating information to a contractor, a client, and other design professionals. If drawings are out of date, are extraneous, are improperly cross-referenced, or are missing, serious costs may be incurred.

Any project set of drawings is made up of sheets, in which the various drawings that describe the project. Every drawing has at least two parts to it. The drawing title and the design. A drawing title is an annotation symbol that is part of a drawing and serves to identify that drawing. The drawing title includes such information as the drawing name, drawing number, sheet on which it resides, scale at which it is drawn and sometimes the project. Callouts, defined below, point to the drawing title. The design is the graphics that convey the design intent.

Drawings are cross-referenced throughout the set by using callouts. A callout is part of one drawing, and points to and provides information about another drawing that contains additional information. Generally this additional information takes the form of another drawing. For example, a symbol is placed in a drawing that has a line “cutting” through a wall in a floor plan. This symbol (the callout) points to a partial section, which is another drawing.

A main source of expense for any design professional, in terms of time and money, is the coordination of the information in the drawing title and the callout. Coordination and management of this information is typically done manually, which takes time, and is prone to errors and omissions. Equally important, however, is the coordination of the graphics themselves. The design professional must ensure that the design is correctly and accurately conveyed to those who will use the drawing, for example, contractors, sub-contractors, the owners, and the public.

It takes an incredible amount of time to coordinate the drawing titles and callouts, and then to maintain that coordination. More specifically, the designer needs to make sure that the drawing and sheet numbers on the callout match those of the drawing title. However, the drawings are dynamic. Throughout the design phase, which could cover months or even years, drawings move to different sheets, drawings get renumbered, and callouts get moved or eliminated sometimes by accident. It is very difficult and time consuming to review the location of a callout against what is actually drawn in the target drawing. For example, the callout for a given wall connection detail may be properly coordinated with the drawing to which it points (the numbers are in synch), but the target drawing itself is not the one that represents the cross section of the wall identified by the callout.

Using current design tools, it is very difficult to navigate from a callout to its intended target drawing. This navigation is done in the context of reviewing callouts and their target drawings. Typically, a “check set” of drawings as they currently exist is printed out. This takes time and money. Also, the check set is immediately out of date, since work almost never stops simply because a check set is printed. The real cost of verifying callouts is a result of sheer volume, as each small amount of time it takes to check a single callout is multiplied by every cross-reference throughout the project set. There are literally hundreds—possibly thousands—of callouts and drawings in any project, small or large.

Past attempts at simplifying this process have been inadequate. For example, in a known manual method of checking cross-references, all callouts and drawing titles are “unintelligent”, and are drafted with basic tools, either by hand or on a computer. The reviewer makes hard copy prints of the sheets to be coordinated. Each callout and target drawing in the printout is visually checked and highlighted, to check off verified callouts and drawings. Red ink is used to mark changes to any callout or drawing title information. A draftsperson picks up the redlines and makes the changes to the originals, whether in a CAD system on the computer or with pencil or ink on the hand drawings. There is no automation of the editing or correcting of the callout and drawing title information.

The manual method has several drawbacks. It is very time-consuming and is prone to errors, since it is so time-consuming and tedious. There is no automatic dynamic coordination of the data, so there is a constant danger that callouts and drawings are out of synch until the next coordination is performed and all redlines in the check set are picked up.

A semi-automated method of checking cross-references has been proposed. In this method, callouts and drawing titles are placed with annotation tools or with standard drafting tools via a CAD program on a computer. An automated tool in the CAD program is provided for creating hyperlinks between callouts and drawings. All callouts are tagged with the relevant target drawing information. A hard copy print-out of the sheets to be coordinated is made. The CAD files are opened and the hyperlinks are used to jump from a callout to the linked drawing title to verify the information in both. As callouts and drawing titles are verified, they are checked off on the print-outs to keep track of what has been verified. Required changes to the callouts and drawing titles are either redlined on the print outs for a draftsperson to pick up later, similar to manual method above, or the necessary changes can be made directly by changing the CAD files. Either way, standard drafting tools are used and there is no automation of the editing of callout and drawing title information.

In another semi-automated method callouts and drawing titles are placed with special annotation tools provided by the software vendor of the CAD application. Placing a callout a drawing creates or flags for creation a drawing title, which is generated automatically or semi-automatically. The callout and drawing title are linked such that if one changes, the other changes. The only example of this method known to the inventors is Autodesk Revit. However, Revit has several limitations. Only one callout can point to any target and maintain intelligent two-way linking. Additionally, the links are designed to exist exclusively within a single file. There is no ability to link to or from drawings or callouts outside the current file. The single-file limitation makes this method useful only for very small projects, for example projects that only necessitate a single person working on the job at any given time.

The Revit method also has several major drawbacks. As mentioned above, it only works in a single file. This makes it virtually ineffective for any project requiring more than one person to work on the job, which constitutes the vast majority of all projects worldwide. In fact, on projects where only one person is involved, it is a fairly straightforward and easy task to coordinate design data. A two-way automated linking system is really only useful if it can support many people working on many files in many locations, where communications are more difficult and coordination is far more time-consuming.

Accordingly, there is a need for a system and method that can automatically coordinate drawings and callouts. The system and method should automatically update and maintain links between a callout and its target. Data links across a plurality of files should be maintained.

### SUMMARY OF THE INVENTION

In an exemplary embodiment of the invention, a method for linking data across an AEC project where the data is arranged in a plurality of files is provided. The method comprises defining a link source located in a first of the plurality of files; defining a link target located in a second of the plurality of files; and establishing a bidirectional link between the link source and the link target.

Embodiments of the invention can also be used in an AEC project including a plurality of design file comprised of models, with each model being comprised of a number of elements, the elements being organized into drawings that are arranged on a number of sheets. In another exemplary embodiment of the invention, a method for establishing and maintaining bidirectional links between data in the plurality of files is provided. The method comprises receiving an identification of a link source. An identification of a link target is also received. A dependency linkage is associated with the link source, wherein the dependency linkage references a link description sufficient to locate the link target. The link source, link target and link description are indexed in a database.

In another embodiment of the invention, a method of maintaining a bidirectional link between data in a file checked-out from a content management system to a user computer and data in at least one file maintained at the content management system is provided. In the method, a first file is scanned at least when it is one of checked in and checked out of the document management system to locate a link in the file. Information is gathered from the first file regarding a source and target of the link. It is determined if an element in the file is the source or the target. The information is the stored in a database. The information in the database is automatically updated when a second file is corresponding to the other end of the link is checked in to the document management system to reflect changes made to the end of the link in the second file. The changes are applied to the information in the first file.

In a further embodiment. a unique document ID is assigned to each document in the project and to each element in the first file. An annotation element is defined in the first file. A dependency linkage is attached to the annotation element. A link description containing the information about the target is created, wherein the dependency linkage refers to the link description.

In another exemplary embodiment of the invention, a system for linking data is provided. The system includes a database storing a plurality of files that are part of a project, the files being comprised of a plurality of elements. A content management system controls access of users to the files and assigns a unique document ID to each document in the project. Means for establishing a bidirectional link between a first element in a first of the plurality of files and a second element in a second of the plurality of files is provided. Means for updating the link, the first element and the second element to reflect changes made to the first or second element is provided.

The above described embodiments of the invention provide numerous advantages. The time spent coordinating documents is greatly reduced, if not eliminated. The quality of document sets is better; drawings are better coordinated (if not perfect). Many drawings and callouts can be managed across many documents stored in multiple data sources across multiple geographic locations (in contrast to other systems to date). Links can be created and two-way links can be managed across documents or files (in contrast to other systems to date). Links can be leveraged by other software applications. Links can be created, modified, deleted, and generally managed outside of the design file. Links are available to non-CAD applications for review and even managing.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a diagram of system according to an embodiment of the invention;

FIG. 1 is a diagram of a an embodiment of the invention including a client program and a server program;

FIG. 3 is a is a diagram illustrating a callout;

FIGS. 4A-4F illustrate an example of design actions;

FIG. 5 is a diagram illustrating movement of a drawing within a sheet;

FIG. 6 is a schematic diagram of a link between a source and target; and

FIG. 7 is a schematic diagram of a process for automatically maintaining links.

### DETAILED DESCRIPTION OF AN EXEMPLARY EMBODIMENT OF THE PRESENT INVENTION

In an exemplary embodiment of the invention, a system and method for linking data across a plurality of files and for automatically maintaining these links is provided. The exemplary embodiment is described below in the context of an AEC project, with a focus on links between drawings in the project, for example, links between drawing titles and callouts. However, the system and method are equally applicable to other environments, as well as to other design documents and data in an AEC project, for example text specifications.

Many of the terms used herein have developed various meanings to different people. In addition to those terms defined above, the meaning of the following terms as used herein is set forth below in order to avoid confusion.

Design—A group of graphic elements (lines, arcs, circles, solids cubes, surfaces, etc.) assembled together to convey an idea or design intent. There is no annotation as a design may be used as part of several drawings.

Annotation—Non-“real world” items such as text, symbols, callouts, and dimensions placed on a drawing to describe real-world items such as walls, pipes, equipment, and columns.

Drawing—A design plus annotation, including a drawing title. With very few exceptions, a drawing is always “called out” from one or more other drawings with a callout.

Sheet—A group of drawings assembled together for publishing. A sheet always has a name, number, and various other attributes that identify it.

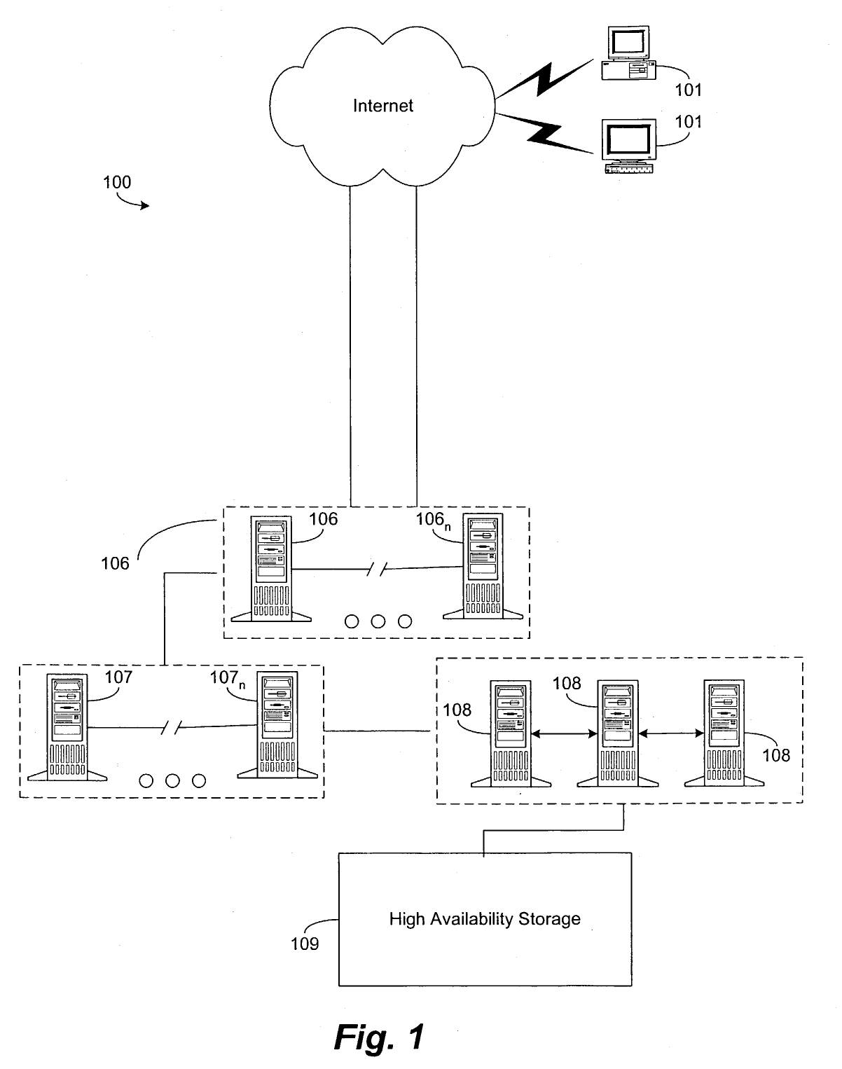

Referring now to FIG. 1, information and data relating to a design project, such as design files, are stored in databases 108 and high availability storage 109. Clients 101 can access the database 108 through servers 106, 107. A copy of the information stored in the database may be downloaded from the database to the Client 101. A user can then manipulate their own copy of the information in any manner. The users can add callouts in their working file that point to other files not present on their computer. The master copy of the design file should always be maintained on database 108. Preferably, any changes made by a user must be saved to database 108 in order to be viewed or worked on by other users.

FIG. 2 shows a preferred embodiment of the present invention which includes two separate computer programs: a server program 110 and a client program 112. These two programs are loaded into memory and executed on the same user computer, or they can be loaded on two different computers and connected by a computer network, or they can be combined into a single program.

The server program 110 is the central hub for controlling access to the project data in the database, and for coordinating and recording changes to project data. The server program 110 executes on application servers 107 and can assign a ID to each document in a project. For a given project, there should be one server program 110 available over a computer network. The server program 110 creates opens, operates on, and maintains the databases. Preferably, the database is a single file or a controlled collection of files containing the elements that comprise the current version of the project. However, the database can also be some other form of long-term storage facility such as a structured store or a relational database.

As described above the information stored in the database is typically organized into design files. Multiple users can download and work on different files at the same time. A first file checked out from the database by one user might include a cross-reference, such as a callout, to data, for example a drawing, in a second file that resides in the database or is being worked on by another user. A link is established between the cross-referenced data in the first and second files. The link is a bi-directional link. At a high level, these links can be thought of as managed cross-references, similar to those used in Word or Excel. These links can also be thought of as similar to hyperlinks in a web site, with the very important distinction that hyperlinks are not managed. Managed means both the source and target of the cross-reference are maintained so that if either changes, the other can respond appropriately.

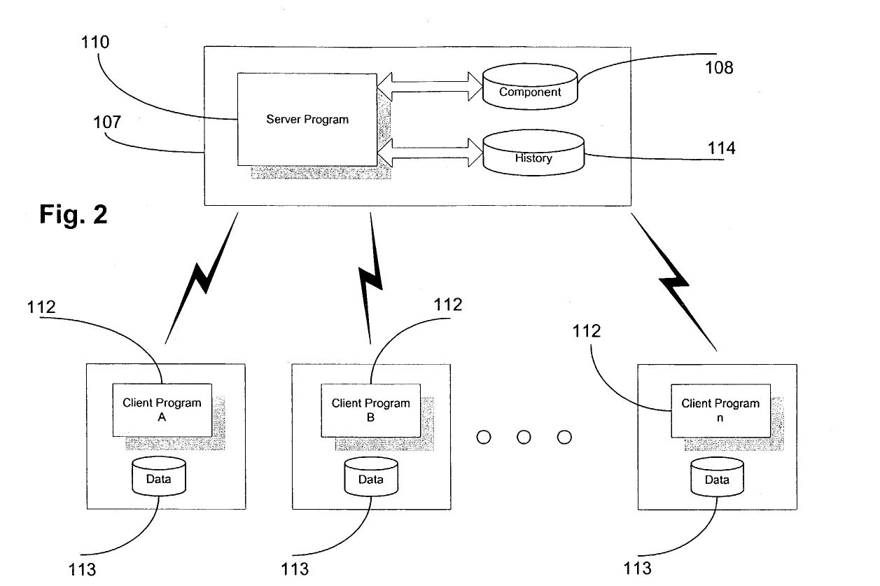

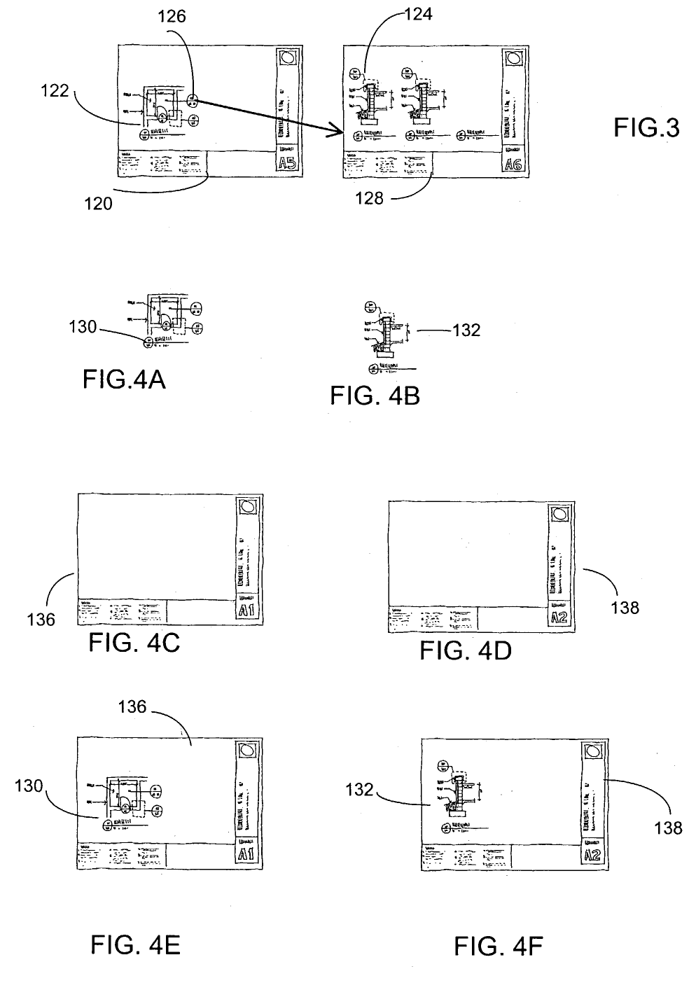

Any link has two sides to it, a link source and a link target. The link source is typically the drawing and sheet in the file where the callout is placed. The link target is the drawing and sheet to which the callout points. The target may be in the same file as the link source, but is most likely in another file. FIG. 3 illustrates an example of a link source and a link target. A sheet 120 is sheet number A5 and includes a first drawing 122. Drawing 122 is a plan view of a room in a building. A more detailed drawing is provided on another sheet in order to more completely describe the design of the room. Sheet 124 is sheet number A6 and includes several detailed views of cross-sections of a wall. The different cross-sections have their own drawings numbers, drawing 1, 2, 3, etc. Drawing 122 in sheet 120 includes a callout 128 that refers to the first drawing 126 on sheet 124. The callout 128 serves as the link source and drawing 126 on sheet 124 serves as the link target.

There is usually at least one entity on either side of a link. In the context of drawings, there is typically one callout on the source side of the link and one drawing on the target side of the link. A drawing can serve as the target for multiple design links, but there is no relationship between these links. Each link between a callout and a drawing is treated individually and should be independent from other links. The link target can also be the drawing title for the target drawing. By keeping the links independent from each other the target of a callout may be changed without having to think about any other related callouts. For example, if a callout points to the wrong drawing, the callout can be modified to point to the correct drawing.

In order to establish a link, at least one side of the link should be defined, that is, either the source or target drawing should already be created. If both a source and a target drawing is defined, a callout and drawing title can be placed and immediately establish both sides of the link. If only the source drawing is defined, a callout can be placed and immediately establish the source side of the link. The target side of the link can be established later. If only the target drawing is defined, a drawing title may be placed with no links, then the source side of one or more links that point to this drawing is established later.

Technically speaking, the Design Link data must be embedded in an element in the DGN file. The Source data of the Design Link is always in a Callout; you cannot establish the Source without a Callout. When you place a Callout, you establish the Source. The Target data of the Design Link is always in a Drawing Title; you cannot establish the Target without a Drawing Title. When you place a Drawing Title, you establish the Target.

The exemplary embodiment of the invention described herein provides three main areas of functionality. The first area is the ability to establish links. A user must be able to establish links between drawings, either during or after the placement of the drawing title or callout. The second area is the ability to manage links. Users should be able to move, change, and delete drawings that are linked, and must be able to easily create new drawings that become linked. The links should be automatically managed during these operations. Users should also be able to manually break, heal, and otherwise change links. The third area is the ability to review links. Users should be able to review existing links and review the drawings on either side of the link. Once the links have been established, the actions of the user are monitored and reacted to, enabling the user to do many powerful things. Some of the functions performed are described below.

Referring now to FIGS. 4a-4, some of the operations typically performed by a designer and the corresponding functionality and operations provided by an exemplary method and system for managing links are described. FIG. 4 is a schematic view of a drawing 130 created by a designer using a design program such as MicroStation. As the designer creates the drawing 130, information about the drawing is gathered and recorded. This information may include the location of the drawing in the file, as well as other information. As the designer continues the design process, drawing 132 is created. Information regarding drawing 132 is also gathered and recorded. Drawing 132 is a detailed view of a cross-section of one of the walls that is depicted in drawing 130.

As mentioned above, the various drawings created by the designer are typically organized into sheets. The sheets are part of the final submission that is provided for review either at predetermined milestones or at the completion of the project. Here, the designer creates sheets 136, 138 which have sheet numbers A1 and A2 respectively. Information regarding sheets A1 and A2, such as the sheet's location in the project, its sheet number, etc. are gathered and recorded. The designer then places drawing 130 on sheet number A1 and places drawing 132 on sheet number A2. As the design is created and modified, the recorded information regarding the drawings and the sheets is updated. For example, when drawing 130 is moved, the data record of drawing 130 is updated to reflect its new location in the project. In this example the data record is updated to include the new sheet, sheet number A1, in which drawing 130 resides, as well as its location within that sheet. The data record of sheet 136 is also updated to reflect the addition of drawing 130 to sheet A1, along with the location of drawing 130 within sheet 136. The data record of drawing 132 and the sheet 138 are also updated in a similar manner. The location of drawing 132 in the project, that is the sheet in which drawing 132 resides and its location within that sheet is updated into the data record of drawing 132. The data record of sheet 138 is also updated by recording the addition of drawing 132 and its location within sheet number A2 in its data record.

It is desired to place a callout in drawing 130 to drawing 132, as drawing 132 is a detailed view of a wall depicted in drawing 130. This is done by placing a callout on drawing 130 that refers to drawing 132. This can be done using an annotation tool provided in the design software. When the annotation tool is selected, the designer is presented with a list of link targets available in the project. This information is provided from the database 108. The designer can browse and select a link target from the display. In this example, drawing 132 is selected as the link target. A callout is placed on drawing 130 establishing drawing 130 as a link source. By having the callout refer to drawing 132, drawing 132 is established as a link target. When the callout is created, data regarding the location of the link target is automatically written into the callout based upon the data gathered about the target location in the various drawings and sheets comprising the project. For example, data is written into the callout in drawing 130 indicating that the callout points to drawing number 1, in sheet A2. The process of creating a link target and a link source and link them together is described in more detail below.

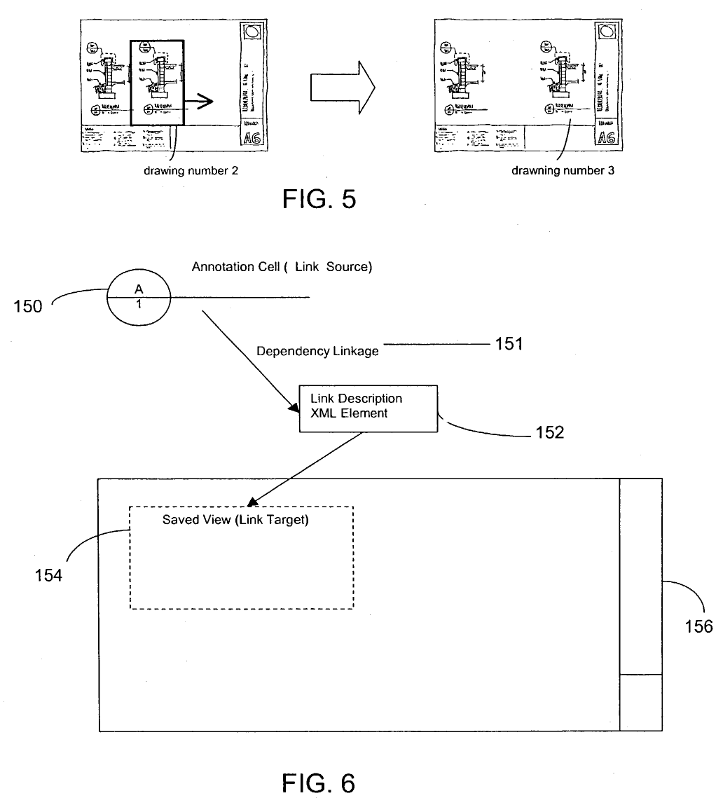

Data regarding the link, link target and the link source is collected as files are checked into and checked out of the database 108. The information is mapped to form a bi-directional link between the link source and the link target. The bi-directional link is maintained and automatically updated as the design file is modified. For example, a drawing is moved within one sheet from one location on that sheet to another location on the sheet. This action does not result in a change in the link. This is because the data describing the drawing has not changed. The name of the drawing and the drawing number remain the same so the link remains valid. In comparison, consider the case when a drawing on a sheet is moved to a different location on the sheet and the drawing is renumbered, as shown in FIG. 5. This may occur, for example, when another drawing is to be inserted before the target drawing. If the link is not updated in this instance, it will point to the wrong drawing, the newly inserted drawing. Accordingly, it is detected that the target drawing has moved and the target data for all links that point to that drawing is automatically updated. Additionally, the source data for all links that originate within that drawing are also updated automatically. This is done utilizing the mapping of the links stored in database 108. Along the same lines, whenever a sheet is renamed and/or renumbered, all data records that use that sheet as a link source or a link target are automatically updated. For example, the database contains information that drawing 130 of sheet 136 includes a callout. The callout references drawing 132 on sheet 138. Similarly, the database includes information that drawing 132 is a link target for drawing 130. The relationships between the link targets and link targets is tracked and updated.

Additionally, using the same type of technique, any graphic symbols, such as callouts, on the drawings are updated. For example, the reference data for annotations that use a renumbered sheet as a target are updated with the new sheet number and/or name. In a similar manner, whenever a sheet is removed from a project set, all callouts that have a link target on that sheet are automatically flagged to be resolved. The callouts can be resolved either by removing them from the drawing, that is making the callout invisible, but not actually deleting it, or by blanking out the text so that the callout does not refer to a missing sheet. Whenever the target of a link is changed to point to a new drawing, or the source or target of a link is broken and then later recreated to a different drawing, all relevant records are updated to reflect the change and maintain the bi-directional link.

Maintaining bi-directional links between the link source and the link target allows either end of the link to be reviewed and verified from the other end of the link. For example, a designer can click on a given callout in a drawing. In response to this action, the link from the callout is traced to the target drawing and a rendition of the target drawing is published. Publishing encompasses plotting or printing to hard copy or digital format for review. This is preferably done without exiting the current design session. Options may be provided in the published view of the target drawing to close, redline, or open the drawing for editing. In a similar manner, if a user clicks on a given drawing title (link target), the link from that drawing is traced and a list of all the drawings that point to this drawing as their link target is displayed. Options may be provided in the published view to view any one of the listed drawings, after which the options just mentioned regarding the published view may also be provided. Access to the various functionality can be provided either through tools included in the design program or through a separate interface.

The automated linking of design data across a project and automatically maintaining the links as described above can be achieved using the following approach. As mentioned above, any link has at least two sides, a link source and a link target. The link source and link target must be defined with sufficient specificity so that they can be easily located and the bidirectional link maintained. In a typical design environment, as described above, drawings are organized into sheets. The location of the link source and link target within a file needs to be defined. This can be done by specifying the sheet and the location within the sheet where the link target and link source are located. To do so, the location of the sheet and the drawing is needed. This inoframtion is contained in a sheet definition and a drawing defintion. A sheet definition for the sheet on which the link source resides is stored in the database. The sheet definition includes at least one of a name, description and sheet number. This allows the sheet to be differentiated from all the other sheets in the file or project. Additionally, a sheet may include many different drawings. Therefore a drawing definition for the link source is also stored in the database. The drawing definition should include at least one of a name of the drawing, a description of the drawing, the sheet number on which the drawing is located, and the drawing number. Link sources are typically call-outs. Call-outs usually include the sheet number and the drawing number of the target therein. Those portions of the call-out that refer to information regarding the link target are referred to as reference data. The reference data may include, for example, the sheet name or detail number of a target drawing.

FIG. 6 illustrates an example of a link between a link source and a link target. A link source 150 is linked via a link description 152 to the link target 154. The link description 152 is associated with the link source 150 by a dependency linkage 151. A link source 150 is an element in a design file that can be tracked by a single element ID. The link source is tagged with information regarding the link target, for example the sheet and drawing number for the link target. Each occurrence of an element with a dependency linkage attached to it is indexed in the database using its element ID. Therefore, if the link source is logically comprised of multiple elements, a single element from the logical group is selected as the ones to receive the dependency linkage. In order to produce a list of all link sources for a single file, the file is scanned for all elements that have a dependency linkage attached to them. The presence of a dependency linkage is also an indication that these elements should be indexed into the database. This allows a project wide list of link sources to be produced.

A link target is the target described by a link description. The link target can be in the same file as the link source, but is most likely in a different file. In FIG. 6, link target 154 resides in file 156. Any element can be a link target. The requirement is to be able to link to a specified region or a specified graphical element within a specified design file. A link target can be any single element or a defined group of elements that has a target identifier attached to it. A target identifier may be a target XML fragment. The target identifier identifies the element as a target. The target identifier also servers as a place to attach data about the target, for example, the reference data. An example of a target XML fragment schema is depicted below.

<Target type=“x” name=“x” shortName=“x”>

| | |
|---|---|
| Type | Int32 - The target type. |
| Name | String - The display name used to identify |
| | the target within a pick list. |
| ShortName | String - The annotation reference data |
| | (abbreviation) associated with annotations |
| | that point at this target. |

As described above, a dependency linkage 151 may be used to associate the link source 150 to a link description 152. The dependency linkage 151 is an element linkage that relates one element to another. This functionality is available in current version Microstation and is built upon with the link description to provide a bi-directional link. The link description 152 identifies a link target. The link description 152 stores enough information so that the link target can be later found. For example, link description 152 may include information that link target 154 resides in file 156, along with a sheet number and drawing number. The link description 152 can be implemented as an XML element that contains information about a target. XML elements are used as they provide a flexible way of storing additional information about the target. The link target can be an element in the same file as the link target, a reference file, or even in a separate design file that is not attached to the file containing the link target. An example of a link description XML schema is depicted below.

<Link sourceDescr=“x” targetDocName=“x” targetDocId=“x” targetElementId=“x”/>

| | |
|---|---|
| SourceDescr | String - Optional information about the |
| | link source. |
| TargetDocName | String - Target file name. No/NULL value |
| | implies current file. |
| TargetDocId | String - The globally unique document ID. |
| | No/NULL value implies a reference to an |
| | unmanaged file unless “targetDocName” is |
| | NULL and the current file is managed. |
| TargetElementId | Unsigned Int64 - If the link target is a |
| | target saved view, the element ID of the |
| | saved view. |

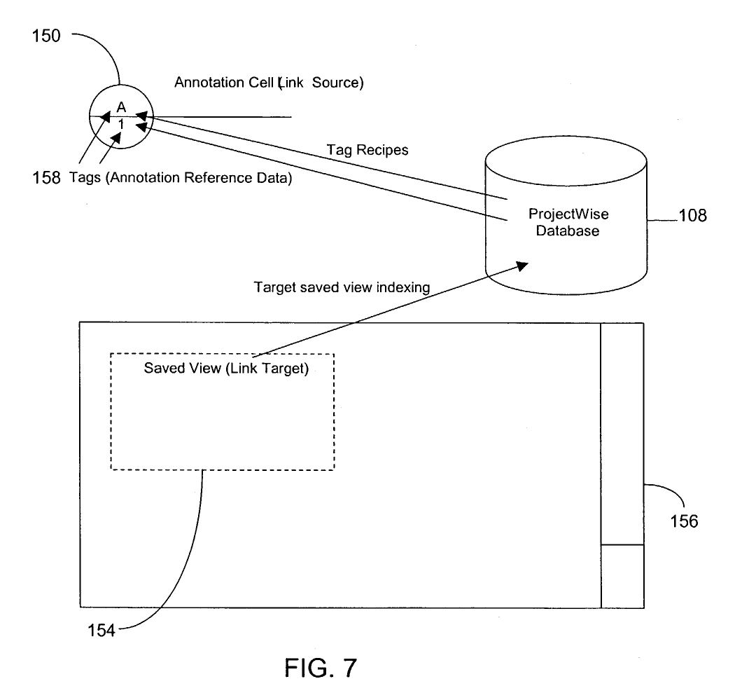

Whenever a link source or target drawing is modified for example, moved to a new location or given a new name, it may be necessary to update the other end of the link with this information. In order to support the synchronization of the data for the link target and link source, a recipe is provided. A recipe is an XML fragment that is attached to a tag or text element. The recipe describes how to update the value of the tag or text element. When the recipe is evaluated, the value is modified according thereto. For example, with reference to FIG. 7, a link has been established between link source 150 and the link target 154. The file 156 containing the link target 154 is then checked out from the database 108 and modified, for example, moved to another location on a different sheet. When the file 156 is checked back into the database 108, the recipe is used to update any links that point to drawing 154 as a link target. The tag recipe associated with the reference data is then used to update the reference data stored in the link source with the new information for the link target. When the link target is checked back into the database, the file is scanned for elements with attached recipes. The database maintains knowledge regarding which link sources point to which link target. The recipe is used to calculate a new value for the reference data based on the change to the link target. The new value for the reference data is then written into the tag element, which represents the reference data in the link source. In this manner, synchronization between the information in the link source regarding the link target and the actual location of the link target is maintained. A similar method can be used to update changes made to the link source that need to be reflected in the link target.

The database store information regarding the link target and link source. The following schema is proposed for the database.

Source Table

| | |
|---|---|
| SequenceNumber | Long integer (primary key) that uniquely |
| | identifies this instance. |
| SourceDocumentGUID | The GUID of the design file containing the |
| | annotation. |
| SourceElementId | Unsigned Int64 - The element ID of the |
| | annotation. |
| AnnotationType | Int32 - the annotation type |
| SourceDescription | String - optional description about the |
| | source element. |
| TargetDocumentGUID | The GUID of the design file containing the |
| | target. |
| TargetElementId | Unsigned Int64 - the element ID of the |
| | target. |

Target Table

| | |
|---|---|
| SequenceNumber | Long integer (primary key) that uniquely |
| | identifies this instance. |
| TargetDocumentGUID | The GUID of the design file containing this |
| | target element. |
| TargetElementId | Unsigned Int64 - The element ID of the |
| | target. |
| TargetType | Int32 - The target type. |
| Name | String - The name of the target. |
| ShortName | String - The abbreviation used on |
| | annotations that point to this target. |

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described. For example, the sequence of performing the steps of the methods described above may be varied as long as the above-described dependencies are maintained.

What is claimed is:

1. A method linking data across an AEC project where the data is arranged in a plurality of files, comprising:
defining a link source located in a first of the plurality of files;
defining a link target located in a second of the plurality of files; and
establishing a bidirectional link between the link source and the link target.

2. The method of claim 1, wherein defining a link source further comprises:
storing a sheet definition for the link source in a database;
storing a drawing definition for the link source in the database; and
storing a callout definition for the link source in the database.

3. The method of claim 2, wherein the sheet definition includes at least one of a name, description, and sheet number.

4. The method of claim 2, wherein the drawing definition includes at least one of a name, description, home sheet, and drawing number

5. The method of claim 2, wherein the callout definition includes at least one of the link source, link target, and status.

6. The method of claim 1, wherein defining a link target further comprises:
storing a sheet definition for the link target in a database; and
storing a drawing definition for the link target in the database.

7. The method of claim 6, wherein the sheet definition includes at least one of a name, description, and sheet number.

8. The method of claim 6, wherein the drawing definition includes at least one of a name, description, home sheet, and drawing number.

9. The method of claim 1, further comprising:
detecting predetermined modifications to the link source or the link target; and
automatically updating the bidirectional link to reflect the modification and maintain the link between the link source and the link target.

10. The method of claim 9, wherein the predetermined modification results in a change in at least one of the sheet definition and drawing definition for the link source and the link target and the callout of the link source.

11. The method of claim 10, wherein the change reflects a removal of a sheet from the project and further comprising flagging all callouts referring to the removed sheet to be resolved.

12. In an AEC project including a plurality of design file comprised of models, with each model being comprised of a number of elements, the elements being organized into drawings that are arranged on a number of sheets, a method for establishing and maintaining bidirectional links between data in the plurality of files, the method comprising:
receiving an identification of a link source;
receiving an identification of a link target;
adding a dependency linkage to the link source, wherein the dependency linkage references a link description sufficient to locate the link target; and
indexing the link source, link target and link description is a database.

13. The method of claim 12, further comprising assigning an element ID to the link source.

14. The method of claim 12, wherein the link description is an XML element.

15. The method of claim 12, further comprising storing the link description in the same file as the link source.

16. The method of claim 12, wherein the link source is an annotation.

17. The method of claim 16, further comprising defining reference data for the annotation.

18. The method of claim 17, wherein the reference data comprises a sheet and a drawing number for the link target.

19. The method of claim 18, further comprising automatically updating the reference data for the link source with information about the link target.

20. The method of claim 17, further comprising creating a tag for the reference data and storing the tag with the annotation.

21. The method of claim 20, further comprising creating a recipe that defines how to update a value of the tag and storing the recipe in the tag.

22. The method of claim 21, wherein the recipe is an XML fragment.

23. The method of claim 12, further comprising attaching a target XML fragment to the link target.

24. The method of claim 12, wherein the index is created in a relational database.

25. The method of claim 12, further comprising associating a plurality of different link sources with the same link description.

26. The method of claim 12, further comprising creating an index of annotation elements and including respective link descriptions.

27. A method of maintaining a bidirectional link between data in a file checked-out from a content management system to a user computer and data in at least one file maintained at the content management system, comprising:
scanning a first file at least when it is one of checked in and checked out of the document management system to locate a link indicator in the file;
gathering information from the first file regarding a source and target of the link;
determining if an element identified by the link indicator is the source or the target;
storing the information in a database;
automatically updating the information in the database when a second file is corresponding to the other end of the link is checked in to the document management system to reflect changes made to the end of the link in the second file; and
applying the changes to the information in the first file.

28. The method of claim 27, further comprising:
assigning a unique document ID to each document in the project;
assigning a unique element ID to each element in the first file;
defining an annotation element in the first file;
attaching a dependency linkage to the annotation element; and
creating a link description containing the information about the target, wherein the dependency linkage refers to the link description.

29. The method of claim 28, further comprising storing the link description in the first file.

30. The method of claim 29, wherein the link description is an XML element including at least one of the document ID for the target and the element ID of the target.

31. The method of claim 27, wherein the scanning step searches for dependency linkages.

32. The method of claim 27, further comprising:
assigning a unique document ID to each document in the project;
assigning a unique element ID to each element in the first file; and
attaching a target XML fragment to an element target.

33. The method of claim 28, further comprising attaching a recipe XML fragment to a tag or text element, the recipe defining how to update the value of the tag or text element.

34. The method of claim 33, wherein the applying step comprises:
scanning for elements with recipes attached;
calculating the recipe to calculate a new value for the tag or text element; and
writing the new value into the tag or text element.

35. A system for linking data, comprising:
a database storing a plurality of files that are part of a project, the files being comprised of a plurality of elements;
a content management system controlling access of users to the files and assigning a unique document ID to each document in the project;
means for establishing a bidirectional link between a first element in a first of the plurality of files and a second element in a second of the plurality of files; and
means for updating the link, the first element and the second element to reflect changes made to the first or second element.

36. The system of claim 35, wherein the first element is a link source and the second element is a link target.

37. The system of claim 35, further comprising means for locating and publishing the second element upon a predetermined user operation at the first element.

38. The system of claim 35, further comprising means for updating updates the first element and the link when the second element is moved to a new location.

39. The system of claim 35, further comprising means for displaying all links to the second element.

40. The system of claim 36, further comprising means for placing a callout in the first file and the callout is the link source.

41. The system of claim 36, wherein the link target is a drawing in a sheet and further comprising means for recording a location of the drawing on the sheet and a sheet number of the sheet.

42. The system of claim 41, further comprising means for defining a sheet; and
means for defining a drawing.
